(19) United States
(12) Patent Application Publication
(10) Pub. No.: US 2011/0134524 A1
(43) Pub. Date: Jun. 9, 2011

(54) BIREFRINGENT MATERIAL

(75) Inventors: Mohammad Reza Taghizadeh, Edinburgh (GB); Ryszard R. Buczynski, Warsaw (GB)

(73) Assignee: Heriot-Watt University, Edinburgh (GB)

(21) Appl. No.: 12/937,682

(22) PCT Filed: Apr. 14, 2009
(86) PCT No.: PCT/GB2009/000964

§ 371 Date: Jan. 20, 2011

(30) Foreign Application Priority Data
Apr. 16, 2008 (GB) 0806924.7

(51) Int. Cl. G02B 5/30; C03B 37/028

(52) U.S. Cl. 359/489.01; 65/411

(57) ABSTRACT

An artificial birefringent element having a repeating unit comprising at least first and second layers alternatively stacked, the first and second layers being formed of materials having different refractive indices.

### FIELD OF THE INVENTION

The present invention relates to birefringent materials, and more particularly to an artificially birefringent material and a method of forming the same.

### BACKGROUND TO THE INVENTION

Polarization dependant structures, such as birefringent elements used in waveplates optical axis gratings (OAG), Lyot filters and the like, are currently very costly to manufacture. Birefringent elements are generally formed of materials, which naturally have characteristics of birefringence such as quartz, ruby and zircon. These materials can be expensive, hard to find or produce, and may also be very time consuming to work into a desired shape or form. Therefore, the cost involved with obtaining birefringent elements is high. Also, since the birefringence magnitudes of these kinds of materials exist naturally, it is not possible to tailor them to a desired function.

Known examples of manufactured birefringent materials lie in the inclusion of metallic materials in polymeric compounds. For example, the inclusion of mercury in the 2D layer structure [Cu(tmeda){Hg(CN)2}2{HgCl4}] (tmeda=N, N, N′,N′-tetramethylethylenediamine) and lead in the [Au(CN)2]-based coordination polymer [Pb-(H2O){Au(CN)2}2] (reference Katz, Kaluarachchi, Batchelor, Bokov, Ye and Leznoff, “Highly Birefringent Materials Designed Using Coordination Polymer Synthetic Methodology”, Angew. Chem. Int. Ed. 2007, 46, 8804-8807). However, these polymer based structures have drawbacks such as an upper operating temperature of approximately 50 degrees C.

### SUMMARY OF THE INVENTION

According to one aspect of the present invention, there is provided an artificial birefringent material having at least first and second layers alternately stacked, the first and second layers being formed of different materials and having thicknesses that are such that the material is birefringent.

By varying the composition and thicknesses of the at least first and second layers, the artificially birefringent material may be tailored to exhibit different refractive indices for orthogonal polarisations.

Preferably, the total thickness of a repeating unit of the at least first and second layers is less than the wavelength of light suitable for use with the birefringent material. Preferably, the thickness of each layer is less than half of the wavelength of the light. More preferably, the total thickness of the repeating unit is less than half of the wavelength.

The total thickness of the repeating unit may be in the range of 1-500 nanometers.

The materials may comprise a dielectric, for example a simple dielectric, and preferably thermally matched simple dielectrics, for example, low melting point glasses.

Alternatively, further layers formed of different materials from the first and second layers may additionally be included in the structure.

The subwavelength thickness of the repeating structure ensures that incident electromagnetic radiation sees only an average refractive index, while the lamellar grating structure of the birefringent material produces different effective refractive indexes for different polarisations of incident electromagnetic radiation thus achieving a birefringent effect.

According to another aspect of the present invention there is provided a method of manufacturing an artificially birefringent material having a structure of at least first and second layers alternately stacked to form a lamellar grating, wherein the first and second layers are formed of different materials, the method including the steps of: (i) arranging fibres of at least two dielectric materials in a perform, (ii) heating the optical fibres to a temperature suitable for drawing of the dielectric materials, and (iii) drawing the optical fibres in the perform until the a lamellar grating of the at least two dielectric material layers is formed having a desired layer thickness. The heating and drawing of the optical fibres may be repeated as necessary.

The method may further involve cutting the drawn material into pieces having lengths according to their functions. Additionally, the pieces may be polished or resized as desired.

### BRIEF DESCRIPTION OF THE DRAWINGS

Various aspects of the invention will now be described by way of example only and with reference to the embodiments shown in the accompanying drawings in which:

FIG. 1 is a longitudinal section and a cross section of an artificially birefringent material;

FIG. 2 is a plot of the variation of phase delay between TE and TM components of light incident to the artificially birefringent of FIG. 1, and

FIG. 3 is a flow chart showing a method of manufacturing the material of FIG. 1.

### DETAILED DESCRIPTION OF THE INVENTION

The present invention uses nanostructured optical fibres to create an artificially birefringent material exhibiting different refractive indices for orthogonal polarisations. The birefringent materials in which the invention is embodied consist of bars or layers of at least two different dielectrics placed alternately in a lamellar grating configuration, with a feature size or thickness along the stacking direction of the grating of smaller than half of the lowest wavelength of illumination and having a suitable length along the direction of propagation, so that the material induces an optical phase shift between TE and TM polarised light.

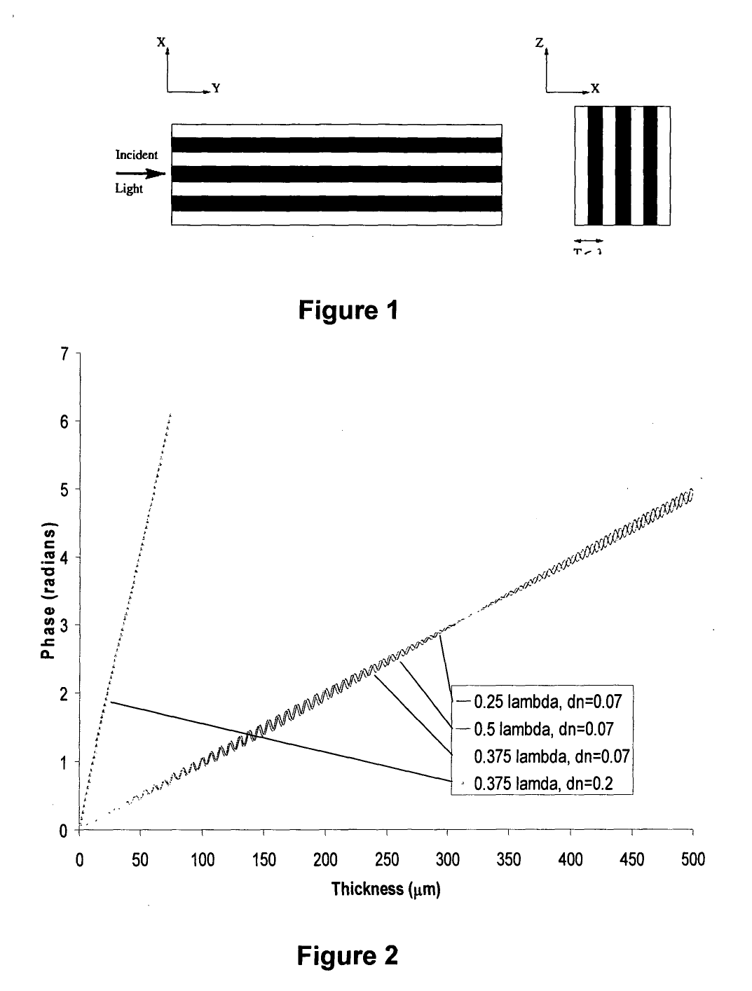

FIG. 1 shows an artificially birefringent material 10 having a plurality of alternately stacked first and second layers 12 and 14. The layers 12 and 14 are formed of different materials and form a lamellar grating. The material used to form the first layers 12 is a glass of refractive index 1.56 (Hereinafter referred to as “Glass 1”). The material used to form the second layer 14 is a glass of refractive index 1.63 (Hereinafter referred to as “Glass 2”). The only requirement for selection of the materials used to form the first and second layers 12 and 14 is that they have different refractive indices. The birefringent effect is greater the larger the difference between the two refractive indices. However, any difference between the indices is enough to produce a desired effect. The two materials are thermally matched.

The thickness of each of the first and second layers 12 and 14 is in the range of 100-250 nm. This means that a combined thickness 16 of one first layer 12 and one second layer 14 is 200-500 nm. The combined thickness 16 is less than half of the wavelength of light suitable for use with the birefringent material. Therefore, in the example where each of the first and second layers 12 and 14 is 250 nm and a combined thickness 16 of one first layer 12 and one second layer 14 is 500 nm, then the artificially birefringent material 10 is suitable for use with light having a wavelength of 1000 nm or greater.

If a stacking direction of the layers is defined to be an x direction, a width direction of the layers is defined to be a z direction and a length direction of the layers is defined to be a y direction, then in use coherent light is directed to be incident on the x-z plane of the artificially birefringent material 10, so that it propagates in the y direction of the artificially birefringent material 10, i.e. along the layers. The sub-wavelength thickness of the layers 12 and 14 ensures that coherent light propagating along the y-axis sees only an average refractive index, while the lamellar grating structure of the birefringent material produces different coupling for different polarisations of incident electromagnetic radiation, thereby inducing a phase shift between the two orthogonal polarisations and achieving a birefringent effect. The size of the dielectric bars along the z-axis is not important to the operation of the birefringent material and can be large enough to allow ease of handling and robust mechanical properties.

The thickness of material in the Y direction of FIG. 1 required to produce a desired phase shift is a function of the difference between the refractive indices dn of the constituent dielectrics as can be seen from FIG. 2, which shows the variation of phase delay between TE and TM components of polarised light as a function of the thickness of the birefringent element in the Y direction. Results for various values of the combined thickness in the X direction as shown in FIG. 1 of the first and second layers (expressed as a function of the wavelength lamda of the incident light), and dn values are shown. As also shown in FIG. 2, a desired phase shift can be introduced between orthogonal polarisations of a predetermined wavelength of light by passing the light through an appropriate length of the artificially birefringent material 10.

Based on the artificially birefringent material 10, it is possible to design and fabricate a wide range of polarization dependent structures that are currently otherwise very costly to manufacture. Due to the flexibility of this approach, new types of devices such as a wavelength independent structure with minimal attenuation can be designed, since the artificially birefringent material 10 does not rely on any absorbing material such as silver particles. Use of high quality pure glass as the material layers of the artificially birefringent material 10 results in low scattering in use and therefore makes this material well suited for high power laser applications.

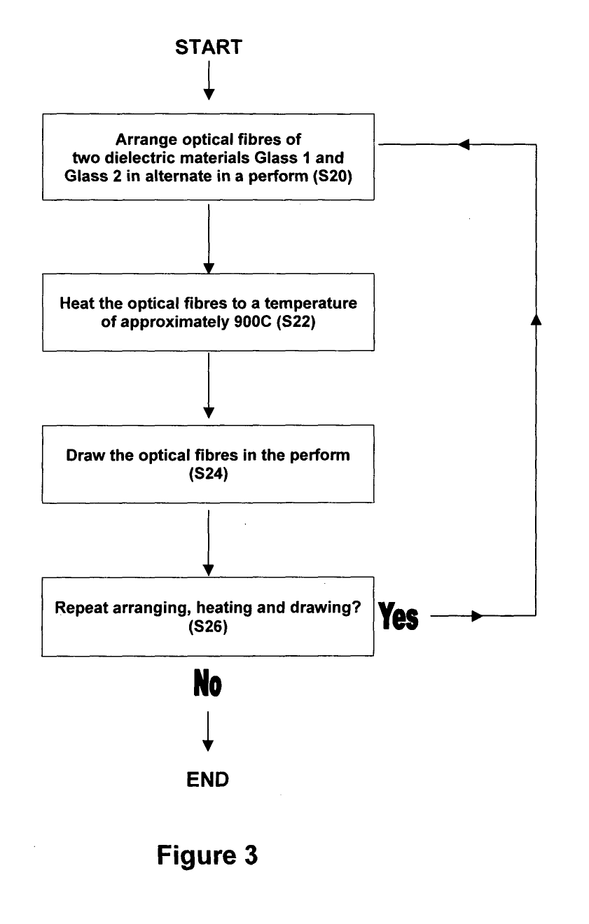

FIG. 3 is a flow chart showing a method of manufacturing the artificially birefringent material 10 of FIG. 1. The method involves arranging optical fibres of two dielectric materials Glass 1 and Glass 2 alternately in a perform (S20), heating the optical fibres to a temperature of approximately 900 degrees C. (S22), and drawing the optical fibres in the perform until a lamellar grating of first and second layers 12 and 14 is formed having a layer thickness of approximately 250 nm (S24). The heating and drawing of the optical fibres may be repeated as necessary (S26). The resultant product may be cut into pieces having lengths according to their functions. The final drawn feature size of the dielectric bars along the Z axis is not important to the operation of the birefringent material and can be large enough to allow ease of handling and robust mechanical properties. Additionally, the pieces may be polished or resized as desired. In addition to this, the resultant product may be used to design and fabricate a wide range of polarization dependent structures.

The method of manufacturing described with reference to FIG. 3 is based on the well-established “stack and draw” method of fabrication currently used in the creation of imaging plates and double-glass photonic crystals. An example of an application of this technique to manufacture optical devices having nanoscale features is described in W02008/009873, the contents of which are incorporated herein by reference. Using similar methods of fabrication, material having artificial birefringence can be made. This overcomes the reliance on naturally birefringent materials and allows birefringent materials to be manufactured to specification using commonly available and cost effective materials.

A skilled person will appreciate that variations of the disclosed arrangements are possible without departing from the invention. For example, the composition, thicknesses and arrangements of the first and second layers 12 and 14 could easily be varied to tailor the artificially birefringent material 10 to have a specific birefringence magnitude. Whilst FIG. 1 shows a structure having two repeating layers of different material, more than two kinds of material may be used. Also, the thicknesses of the material layers can be the same or different. Accordingly the above description of the specific embodiment is made by way of example only and not for the purposes of limitation. It will be clear to the skilled person that minor modifications may be made without significant changes to the operation described.

1. An artificial birefringent element having a repeating unit comprising at least first and second layers alternately stacked, the first and second layers being formed of materials having different refractive indices.

2. An element as claimed in claim 1, wherein the repeating unit has a thickness less than a wavelength of light suitable for use with the material.

3. An element as claimed in claim 1, wherein the repeating unit has a thickness less than half of a wavelength of light suitable for use with the material.

4. An element as claimed in claim 1, wherein the first and second layers have the same thickness.

5. An element as claimed in claim 1, wherein the first and second layers have different thicknesses.

6. An element as claimed in claim 1, wherein the first and second layers each independently has a thickness in the range of 1-500 nm.

7. An element as claimed in claim 1, wherein the first and second layers each independently has a thickness in the range of 100-250 nm.

8. An element as claimed in claim 1 any of the preceding claims, wherein the materials are used to form the first and second layers are selected from: a dielectric;
a simple dielectric; thermally matched simple dielectrics; low melting point glasses.

9. An element as claimed in claim 1, wherein the repeating unit further comprises at least one other layer formed of a different material from the first and second layers.

10. An element as claimed in claim 1, that has a thickness that is selected to produce a desired phase shift.

11. An element as claimed in claim 1, that provides a phase shift that is a function of its thickness.

12. A method of manufacturing an artificially birefringent material comprising:
arranging optical fibers of at least two dielectric materials alternately in a perform;
drawing the optical fibers in the perform; and
repeating the heating and drawing of the optical fibers until a grating of repeating units of first and second layers is formed.

13. A method of manufacturing an artificially birefringent material as recited in claim 12, further comprising:
cutting the resultant product into pieces having lengths according to their functions; and
polishing or resizing the pieces as desired.
